(19) United States
(12) Patent Application Publication
(10) Pub. No.: US 2004/0200860 A1
(43) Pub. Date: Oct. 14, 2004

(54) Fluid dispenser

(75) Inventor: Detmar Buxmann, Saarbrucken (DE)

Correspondence Address: SCULLY SCOTT MURPHY & PRESSER, PC, 400 GARDEN CITY PLAZA, GARDEN CITY, NY, 11530

(73) Assignee: Ursapharm Arzneimittel GmbH & Co. KG, Saarbrucken (DE)

(21) Appl. No.: 10/413,952

(22) Filed: Apr. 15, 2003

(30) Foreign Application Priority Data
Apr. 9, 2003 (EP) 03 008 290.3

(51) Int. Cl. G01F 11/06

(52) U.S. Cl. 222/321.6

(57) ABSTRACT

A fluid dispenser for germ-free fluid is described incorporating at least one material being capable of interacting via an oligodynamically active substance. The dispenser includes a metering pump and inlet and outlet valves. The fluid coming into contact with at least one oligodynamically active substance is present in the region of the outlet valve, of the inlet thereto and/or the outlet therefrom.

The invention relates to a fluid dispenser for germ-free fluids.

In the Pharmazeutische Zeitung, 124, No. 20, of 17th May 1979, on pages 949 and 950, a fluid dispenser is described that has the form of a dropping pipette and is attached to a container containing eye-drops. Inside the dropping pipette a silver deposit consisting of a layer of silver or a difficultly-soluble silver salt is disposed so that airborne germs drawn in with the drops that run back into the container have to pass an antimicrobial (oligodynamical) active silver layer before they enter the container. It is also stated that ceramic rings with silver chloride embedded and having a diameter of 9 mm have been found to be suitable. These ceramic rings can be firmly installed in the droppers of all the usual kinds of pharmaceuticals, eye-dropper bottles simply by pushing them in. This method of introducing the silver deposit into the droppers has the disadvantage that only the drops running back along the walls of the dropper come into contact with the silver deposit, but not the portions of the liquid in the interior of the column of fluid which flows back into the container from the dropper after use in the usual way with the dropper facing downwards. Each use of the eye-drop container thus leads to contamination of the eye-drops. A further disadvantage is that the interior of the container is in contact with the ambient air through the dropper, so that even while it is not being used germs constantly find their way in and lead to contamination of the eye-drops in the container.

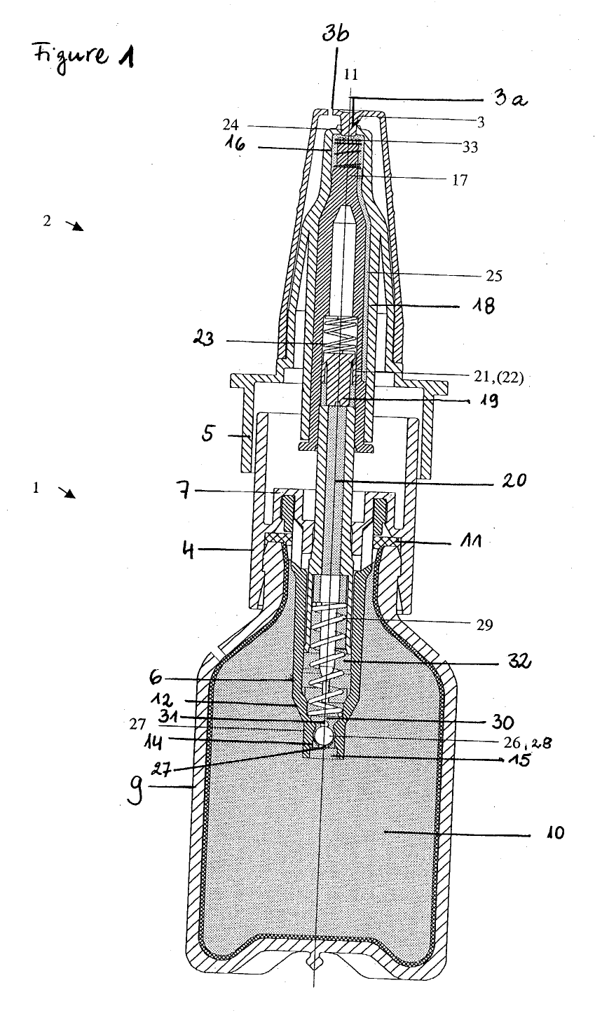

From DE 40 27 320 C2 a fluid dispenser for germ-free fluid is known which comprises a through passage connecting an inlet opening for fluid and a delivery opening for said fluid and having therein an oligodynamically antimicrobial active substance. The device includes a metering pump and inlet and outlet valves. The oligodynamical germicidal active substance is present in the region of the inlet valve and/or the outlet valve. According to FIG. 1 of this document the springs are shown which can be coated with silver. Likewise, the valve ball functioning as the inlet valve consists of corundum having embedded therein a silver material as an oligodynamically effective substance. A disadvantage of this device is that often compatability problems occur due to the presence of silver and oxidation processes which produce undesired by-products.

It is an object of the invention to provide a fluid dispenser of the kind as referred to in DE 40 27 320 C2 which does not cause compatibility problems and prevents the formation of by-products while simultaneously an adequate and comparable microbiological safety (i.e. germ-free application) of the system is maintained.

This object has been solved by the fluid dispenser as defined in claim 1.

The present invention relates to a fluid dispenser for germ-free fluid comprising a through passage connecting an inlet opening for fluid contained in a supply container and a delivery opening for dispensing said fluid and having therein at least one oligodynamically active substance that is in contact with the fluid; a metering pump operating without air pressure compensation and having an inlet valve for closing said inlet opening, said inlet valve comprising a material capable of interacting with the fluid via an active oligodynamically substance and a spring means (29) being in contact with the fluid wherein the inlet valve and the spring means comprise a steel material as an oligodynamically active substance, and a decontamination means is provided in the upper part of outlet passage, said decontamination means comprising a material capable of interacting with the fluid via an oligodynamical substance selected from the group consisting of silver, silver salts, other silver compounds, alloys and nanomers thereof in either metallic or salt form or as a chemical compound thereof.

The subclaims are directed to preferred embodiments of the fluid dispenser of the invention.

The present invention relates further to the use of the fluid dispenser of the invention. The fluid dispenser of the present invention is suitable for dispensing minute amounts of a liquid in various fields such as pharmaceutics, cosmetics and medical devices. The liquids are usually topically applied. Preferred liquids are pharmaceutical liquids such as ophthalmica and nasalia.

The term “interacting” should be defined in the context of the present invention as a type of a surface reaction. The theory is that the interaction takes place close to or preferably on the surface of the material capable of interacting with the germs contained in the liquid. One possible mechanism could be that the contaminated liquid comes into contact with ions derived from metal oxides which has been formed directly on the surface of the material. This contact results in killing the germs. A general rule can be seen in the relationship of the material surface and its size: the larger the surface is, the better the decontamination effect is.

According to the fluid dispenser of the invention, the decontamination means 33 is provided in the upper part of the outlet passage 25. The term “upper part” comprises the region of the outlet passage 25 where still an optimum decontamination can be ensured. In a preferred embodiment of the invention the means 33 is provided on the outer hollow cylindrical part 17.

According to the invention, a particularly intensive germicidal action results from the more prolonged contact between the liquid and the oligodynamically active substance. The metering pump operates without air pressure compensation, so that contamination of the fluid supply through the air flows into the container to effect the pressure compensation in the operation of conventional metering pumps is prevented. The fluid dispenser of the invention ensures that the fluid in the supply container is kept germ-free even during use, so that it is not necessary either to add preservatives or to introduce the oligodynamically active substance into the container.

Particularly when a seat valve is used as the inlet valve, the particularly intensive germicidal action due to prolonged contact of the fluid with the oligodynamically active substance can be obtained by keeping the through passage, at least in the neighborhood of the inlet valve, constantly full of the fluid.

The oligodynamically active substance is located or near to the outlet passage to prevent microbiological contamination by reducing count of potential arising germs from the environment.

According to the invention, the oligodynamically active substance is situated on the closure member of the inlet and outlet valve, or forms at least part thereof.

Alternatively or in addition the oligodynamically active substance may be on the valve seat or valve housing that cooperates with the closure member of the inlet and/or outlet valve, or form at least part thereof. According to the invention, the oligodynamically active substance may be provided on a spring that acts on the closure member of the inlet valve and the outlet valve. Furthermore, the oligodynamically active substance may be provided on at least part of a rising tube, if available, forming the inlet passage to the inlet valve, or form at least part thereof.

Another useful construction is one in which the oligodynamically active substance may be additionally located in the region between the two valves on at least part of the through passage, or forms at least part thereof.

The invention will now be described in more detail, by way of example, with reference to the single Figure of the drawings, which shows in longitudinal section an embodiment of the invention.

As shown in the Figure, the device comprises a metering pump consisting of a cylindrical pump body 1, an operating plunger 2 and a cap 3.

The pump body 1 comprises a first hollow cylindrical body part 4, shown in the drawing as open at the bottom, a second hollow cylindrical body part 5 of bigger diameter (part 5 is part of the operating plunger 2), open at the top in the drawing, and a hollow cylinder 6 that is open at both ends and is fixed centrally on an inwardly directed annular flange 7 in the transition region between the two parts 4,5 of the pump body. The first body part 4 may have an internal screw thread into which a container 9 filled with a germ-free fluid and indicated only generally, can be screwed. As an alternative, instead of the internal screw thread, a snap on closure can be used as shown in the Figure. A seal 11 is provided on the underside (in the drawing) of the annular flange 7 to ensure an air-tight seal between the container 9 and the pump body 4. In the neighborhood of the outlet from the first body part 4 of the pump the hollow cylinder 6 has a conically tapered-down transition part 12 that connects with a cylindrical valve section 14 of smaller diameter leading to a rising tube, if available. The open bottom end of the rising tube forms the inlet opening 15 of the metering pump. As an alternative, the rising tube may be omitted, as shown in the Figure.

The operating plunger 2 comprises an outer hollow cylindrical part 17, shown in the drawing as open at the bottom and closed at the top by a head 16, and a hollow inner cylindrical part 18 extending centrally downwards from the head 16. The diameter of the hollow outer cylindrical part 17 is smaller than that of the first pump body part 4.

A piston 19 that fits inside the hollow cylinder 6 and has a through bore 20 is fixed at its top end in the inner hollow cylinder part 18. A piston valve 21 of an outlet valve 22 that fits inside the hollow cylindrical part 18 is supported between the end part of the piston 19 at one end and at the other end on the head 16 via a spring 23.

An outlet passage 25 leading to a delivery opening 24 on the head 16 is connected to the interior of the inner hollow cylindrical part 18 at the level of the piston valve 21.

In the upper part of the outlet passage 25 or preferably in the upper part of the outer hollow cylindrical part 17 a means decontamination 33 is provided which comprises a material capable of interacting via an an oligodynamically active substance selected from the group consisting of silver, silver salts, other silver compounds and alloys thereof or nanomers in either metallic or salt form or chemical compounds thereof close to the surface thereof.

Silver exhibits the most favourable therapeutically index in terms of concentration in parts per billion. Depending on economical considerations, the means can be made of silver, of another metal coated with silver or of a material having embedded therein the oligodynamically germicidally active substance. In a preferred embodiment of the invention, the means decontamination 33 has a circular shape such as a ring or a spiral. It has been shown that corundum can be one of the convenient materials, when the oligodynamically active substance is embedded in a carrier material.

Depending on the construction of the fluid dispenser and its intended use, the decontamination means 33 can be also provided as a coating. As an example, the coating can be disposed on the outer hollow cylindrical part 17 in the upper part of the outlet passage 25. It is possible to provide a coating made of silver or a coating of a suitable material having embedded therein silver or a silver compound.

It has been shown that in the case of using a coating in the upper part of the outlet passage 25, the silver coating may be suitably a nanocoating comprised of nanomeres. For example, a desired nanocoating comprising silver colloids is described in DE 01 128 625 A1.

According to embodiments of the invention it is possible to provide antimicrobial coatings on parts of the inlet valve 26 and on parts of the pump housing. Said coatings may be applied directly to plastic elements and steel components of the pump.

An inlet valve 26, comprising a ball 28 cooperating with a valve seat 27 is formed in the valve part 14. A spring 29 fixed to the piston 19 is supported on a projection 30 on the valve part 14 and supports the pumping action. The space inside the hollow cylinder 6 between the piston 19 and the valve part 14 is indicated by the reference numeral 32.

The valve ball 28 comprises a steel material as an oligodynamically active substance. In addition the valve seat 27 and the inner side of the inner hollow cylinder part 18 in the region of the piston valve 21 may be coated with a material capable of interacting via an oligodynamically active substance. The piston valve 21 can be made of any inert material such as plastic.

The lower one of the at least two spring means 29 also comprises a steel material as an oligodynamically active substance. In principle, any steel material may be used, as long as the steel material is capable of interacting via an oligodynamically active substance.

It has been shown that a preferred steel material for the above device components is a stainless steel. Generally, a stainless steel contains relatively high amounts of alloy elements such as chromium, nickel, molybdenium, copper, tungsten, aluminium, tantal, niob and titanium, while iron being the remainder representing the major part of the alloy.

It is known that stainless steels are corrosion-resistent. The corrosion resistance is due to an extremely thin and very tough chromium oxide layer on the surface of the steel. It has been shown that an effective killing of germs can be achieved when a chromium containing stainless steel is used as a material for the spiral 29 and the inlet valve 26. Chromium as well as other heavy metals in very small amounts can act as an oligodynamically active substance which kills microorganisms such as bacteria. For example, stainless steel materials such as materials 1.4034 and 1.4401 are suitable steels for the springs and the inlet valve 26. As spring 23 does not come into contact with the fluid to be filled, the upper spring means 23 can be made of a stainless steel material, too.

From the viewpoint of compatibility of the stainless steels, especially under consideration of possible allergic reactions, a nickel-free stainless steel or a stainless steel comprising very low amounts of nickel should be used.

The metering pump of the invention operates without air pressure compensation, that is to say, no pressure compensation takes place in the container 9 through the inflow of air during its operation.

The metering pump of the invention operates as follows: when the user removes the cap 3 and depresses the operating plunger 2 so as to push it into the second pump body part 5 a corresponding movement of the piston 19 against the force of the spring 29 simultaneously takes place. This presses the ball 28 harder against the valve seat 27 and applies pressure to the liquid 10 that has been sucked into the inner space 32 and the through bore 20 during the previous operation of the metering pump. This pressure displaces the piston valve 21 of the outlet valve 22 against the force of the spring 23, so that the connection to the outlet passage 25 is opened and a precisely measured quantity of the liquid 10 is delivered through the delivery opening 24. As soon as the piston 19 reaches its dead centre position, the pressure in the inner space 32 and in the through bore 20 drops so far that the outlet valve 22 closes and the inlet valve 26 opens, so that liquid 10 is sucked out of the container 9. The inlet valve 26 then closes again. Thereupon the user replaces the cap 3 on the plunger 2 and thereby closes the delivery opening 24.

Liquid remaining at the delivery opening 24, in the outlet passage 25, and in the through bore 20, as well as in the inner space 32 and in the inlet valve 29, come into contact with the various locations where the oligodynamically germicidally substances are in contact with the fluid.

The container 9 filled with a germ-free fluid may be made of a flexible material such as a plastic material. In some cases depending on the final use of the device, the container 9 may be composed of an at least two bag system comprising an external part and an internal bag as the main reservoir for the germ-free fluid.

The fluid dispenser according to the invention also comprises a cap 3 to cover and to seal the delivery opening 23. The cap 3 is provided with a pin 13a and a hole 3b. The pin 3a fits in the delivery opening 24 located in the head 16. The hole 3b functions as an aeration means. By passing air through this hole 3b, the excess fluid remaining after use is allowed to evaporate, thus giving still more protection against contamination.

The fluid dispenser according to the invention is perfectly for dispensing minute amounts of liquids of any kinds, preferably a liquid pharmaceutical composition. In a preferred embodiment of the invention the fluid dispenser may be used for suspensing liquid pharmaceutical compositions, such as an ophthalmicum or nasalium. Further administrations are fluids applied as medical devices or cosmetics. The fluid dispenser according to the invention may be available in any size depending on the end use.

1. A fluid dispenser for germ-free fluid (10) comprising
a through passage (32,20,25) connecting an inlet opening (15) for fluid (10) contained in a supply container (9) and a delivery opening (24) for dispensing said fluid (10) and having therein at least one oligodynamically active substance that is in contact with the fluid (10);
a metering pump operating without air pressure compensation and having an inlet valve (26) for closing said inlet opening (15), said inlet valve (26) comprising a material capable of interacting with the fluid (10) via an active oligodynamically substance and
a spring means (29) being in contact with the fluid (10)
wherein the inlet valve (26) and the spring means (29) comprise a steel material as an oligodynamically active substance, and a decontamination means (33) is provided in the upper part of outlet passage (25), said decontamination means (33) comprising a material capable of interacting with the fluid (10) via an oligodynamical substance selected from the group consisting of silver, silver salts, other silver compounds, alloys and nanomers thereof in either metallic or salt form or as a chemical compound thereof.

2. The fluid dispenser according to claim 1, wherein the decontamination means (33) is provided on the outer hollow cylindrical part (17).

3. The fluid dispenser according to claim 1 or 2, wherein said through passage (32,20,25) is constantly filled, at least in the region of said inlet valve (26) with said fluid (10).

4. The fluid dispenser according to at least one of claims 1 to 3, wherein said oligodynamically active substance is provided on the inner side of a cap (3) that can be fitted on to said fluid dispenser to cover said delivery opening (24).

5. The fluid dispenser according to claim 4, wherein the cap (3) is provided with a pin (3a) and a hole (3b).

6. The fluid dispenser according to claim 5, wherein the pin (3a) fits in the delivery opening (24) located in the head (16).

7. The fluid dispenser according to at least one of claims 1 to 6, wherein said inlet valve (26) further includes a valve seat (27) cooperating with the closure member wherein said valve seat (27) is provided with said oligodynamically active substance.

8. The fluid dispenser according to at least one of claims 1 to 6, wherein said outlet valve (22) further includes a valve seat cooperating with the closure member.

9. The fluid dispenser according to at least one of claims 1 to 8, wherein said inlet valve (26) is a ball valve and a valve housing cooperating with a closure member of said inlet valve (26), said valve housing being provided with said oligodynamically active substance.

10. The fluid dispenser according to at least one of claims 1 to 9, wherein said outlet valve (22) is a piston valve and a valve housing cooperating with a closure member of said outlet valve (22).

11. The fluid dispenser according to at least one of claims 1 to 10, wherein the steel material is a stainless steel.

12. The fluid dispenser according to claim 11, wherein the stainless steel contains at least one element selected from the group consisting of chromium, nickel, molybdenium, copper, tungsten, aluminium, titanium, niob and tantal, the remainder being iron as the main component.

13. The fluid dispenser according to at least one of claims 1 to 12, wherein the decontamination means (33) is of a material having a circular shape.

14. The fluid dispenser according to claim 13, wherein the decontamination means (33) is a ring.

15. The fluid dispenser according to claim 13, wherein the decontamination means (33) is a spiral.

16. The fluid dispenser according to at least one of claims 1 to 12, wherein the decontamination means (33) is a coating.

17. The fluid dispenser according to one of claims 13 to 15, wherein the material is corundum having embedded therein the oligodynamically active compound.

18. The fluid dispenser according to one of claims 13 to 16, wherein the material is silver.

19. Use of a fluid dispenser according to at least one of the preceding claims for dispensing minute amounts of a liquid in the field of pharmaceutics, cosmetics and medical devices.

20. The use according to claim 19, wherein the liquids are topically applied.

21. The use of claim 20, wherein the liquid is an ophthalmicum or nasalium.
